(19) United States
(12) Patent Application Publication
(10) Pub. No.: US 2011/0073673 A1
(43) Pub. Date: Mar. 31, 2011

(54) Water supplement member for atomizer

(76) Inventor: Charlie Huang, Tainan (TW)

(21) Appl. No.: 12/585,857

(22) Filed: Sep. 28, 2009

(51) Int. Cl. B05B 1/08

(52) U.S. Cl. 239/102.1

(57) ABSTRACT

A water supplement member for atomizers is revealed. A vibrator corresponding to a movable water delivery device is mounted in a seat so as to convert water to a mist. A water tank is used to supply the water delivery device water. A slot hole is disposed on the water tank for a transparent water supplement container inserted through the seat to be mounted with. Thus water supplement for producing a mist is achieved. Thereby the shelf life of the atomizer is extended. Moreover, the water level can be seen clearly though the transparent design of the water supplement container. Once the water level is lowered, the water is filled. Thus both the vibrator and the water delivery device have longer life time.

### BACKGROUND OF THE INVENTION

1. Fields of the Invention

The present invention relates to a water supplement member for atomizers, especially to a water supplement member that fills water before the water is running out so as to ensure sufficient water supply for producing a water mist. Moreover, by transparent design of a water supplement container, the water in the atomizers is filled in time so as to prevent damage of a vibrator that produces a fine spray of water.

2. Descriptions of Related Art

The water atomizers available on the market include a container for storage a liquid, a cotton strip is set in the container, and an ultrasonic vibrator arranged at the top thereof. One end of the cotton strip is placed in the liquid while the other end thereof is attached on the ultrasonic vibrator closely and tightly. The liquid moves throughout the cotton strip by capillary action. Thereby the liquid is conveyed from the container to the ultrasonic vibrator. When the ultrasonic vibrator starts working, the liquid on the cotton strip is influenced and the liquid molecules are vibrated to be atomized into a spray of droplets (mist).

However, the liquid in the container is not always water. It can be other liquid added with essences. Thus there should be sufficient liquid provided to the cotton strip so as to produce mist by the ultrasonic vibrator. As to the water container of general atomizers, they are always mounted in the atomizer so that it is not easy to see the container. Thus after being used for quite a long time, the liquid or water in the container may be run out but users don't know that and can't fill the liquid in time. The ultrasonic vibrator continues working yet there is no liquid to be acted. This causes waste of the power. Moreover, the essences in the liquid may block the ultrasonic vibrator so that there is no more mist generated. And the life time of the atomizer is further reduced.

### SUMMARY OF THE INVENTION

Therefore it is a primary object of the present invention to provide a water supplement member for atomizers, mainly having a transparent water supplement container, in which users can feed water or liquid before the water or liquid in the atomizer is run out so as to ensure sufficient water/liquid supply of a water/liquid container for generating a mist. Moreover, the block of the vibrator of the atomizer can be avoided.

In order to achieve above object, a water supplement member for atomizers according to the present invention includes a vibrator corresponding to a movable water delivery device and disposed in a seat so as to generate mists. The water delivery device is provided with water by a water tank that is disposed with a slot hole. A transparent water supplement container with a conducting pipe is inserted through the seat to be mounted into the slot hole so as to provide sufficient water for producing mists by vibrations.

Thereby the life time of the atomizers is longer. At the same time, the water level is seen clearly due to the transparent design and the water can be filled in time so that the life span of the vibrator as well as the water delivery device is extended.

The conducting pipe disposed on the transparent water supplement container is mounted into the slot hole of the water tank. Moreover, a flow deflection hole is arranged around an inner surface of the conducting pipe while an assembly slot hole is disposed on the center thereof and is corresponding to a movable rod with a stopping block. An elastic member is disposed between the stopping block of the movable rod and the assembly slot hole, around the moveable rod, and a water stop stopper is sleeved on the other end of the movable rod. Furthermore, a projecting block mounted in the slot hole of the water tank is corresponding to the movable rod assembled in the conducting pipe so that the movable rod can extend and retract. Thus the water stop stopper is against the flow deflection hole for closing the flow deflection hole tightly or is released from the flow deflection hole for water supplement.

The water supplement member for atomizers of the present invention further includes a light source arranged at the seat and a corresponding receiving slot disposed on the transparent water supplement container so that light is generated to improve the aesthetics.

The water supplement member for atomizers of the present invention further has a water inlet set on the bottom of the transparent water supplement container and a seal corresponds to the water inlet for closing the water inlet tightly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a partial explosive view of an embodiment according to the present invention;

FIG. 2 is a schematic drawing showing a cross section of an embodiment according to the present invention;

FIG. 3 is a schematic drawing showing a use state of an embodiment according to the present invention;

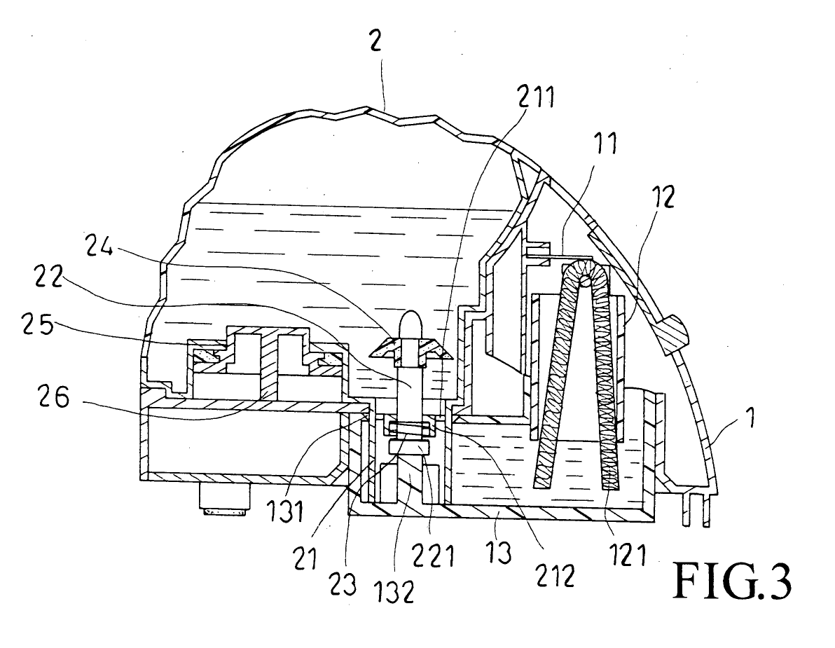

FIG. 4 is a schematic drawing showing another embodiment according to the present invention.

### DETAILED DESCRIPTION OF THE PREFERRED EMBODIMENT

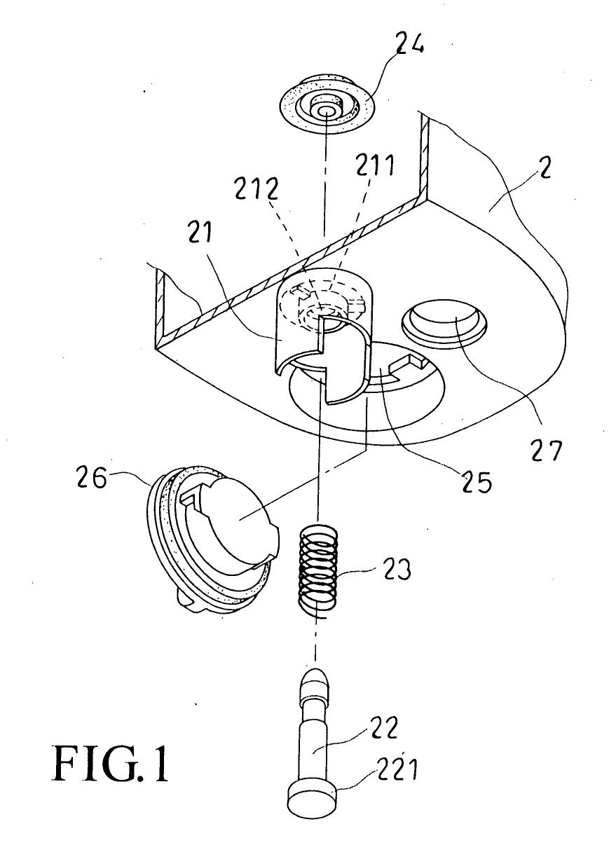

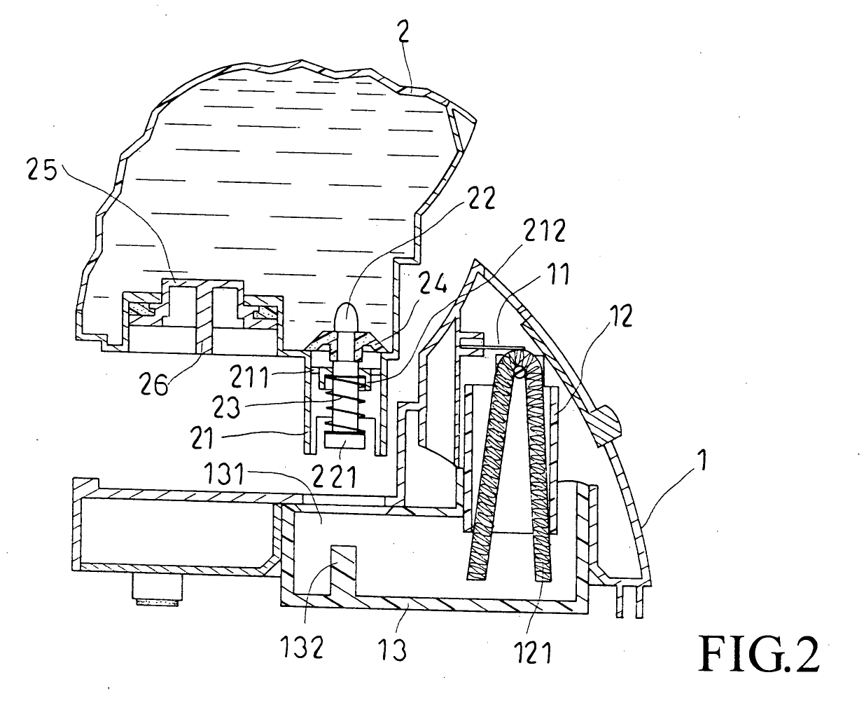

Refer to FIG. 1 and FIG. 2, a vibrator 11 is mounted in a seat 1 and is corresponding to a moveable water delivery device 12. A water tank 13 supplies the water delivery device 12 water so as to convert water to mists by the vibrator 11.

A slot hole 131 is arranged at the water tank 13 and is corresponding to a transparent water supplement container 2 with a conducting pipe 21. By the conducting pipe 21 of the transparent water supplement container 2 inserted through the seat 1 and mounted into the slot hole 131, water is supplied to be atomized for producing a mist.

Refer from FIG. 1 to FIG. 2, the vibrator 11 mounted in the seat 1 is a spring distributed with micro-holes. The vibrator 11 is corresponding to the water delivery device 12 with capillary water-absorbing fiber 121 that attracts water due to capillary action. A water tank 13 supplies water to the capillary water-absorbing fiber 121 of the water delivery device 12. A slot hole 131 is arranged at the water tank 13 while a projecting block 132 is mounted in the slot hole 131. A flow deflection hole 211 is arranged around an inner surface of the conducting pipe 21 of the water supplement container 2 and an assembly slot hole 212 is disposed on the center thereof and corresponding to a movable rod 22 with a stopping block 221. An elastic member 23 is disposed between the stopping block 221 of the movable rod 22 and the assembly slot hole 212, around the movable rod 22, and a water stop stopper 24 is sleeved on the other end of the movable rod 22.

In use, firstly water is filled into the transparent water supplement container 2 through a water inlet 25 and then the water inlet 25 is closed by a seal 26. Now the movable rod 22 is influenced by the elastic member 23 and water pressure so that the water stop stopper 24 presses against the flow deflection hole 211 tightly and closely. Then the conducting pipe 21 of the water supplement container 2 inserts into seat 1 correspondingly to be mounted into the slot hole 131 of the water tank 13 so that the projecting block 132 stoppers the movable rod 22 correspondingly. Moreover, the water stop stopper 24 of the movable rod 22 is released from the flow deflection hole 211. Thus the water supplement container 2 is connected with the water tank 13 for water supplement. The capillary water-absorbing fiber 121 of the water delivery device 12 continues to attract water and the water is converted into a mist by the vibrator 11. When the water level is observed through the water supplement container 2, below a certain degree and the water supplement operations are required, the seal 26 is opened for water supplement through the water inlet 25.

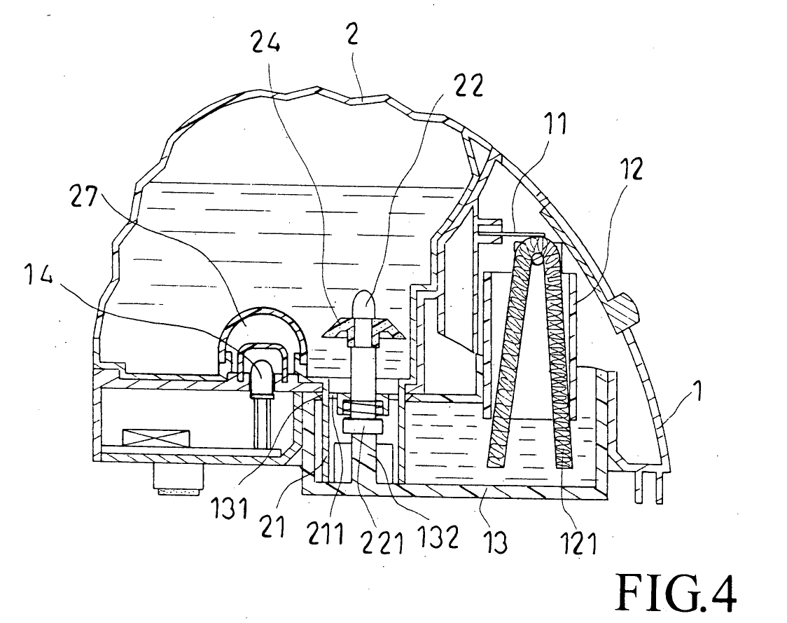

In summary, the life time of the atomizer is extended and the water level is observed clearly through the transparent design. The water is filled in time so as to ensure the life time of the vibrator 11 as well as the water delivery device 12. Furthermore, refer to FIG. 4, a light source 14 is further disposed over the seat 1. Corresponding to the light source 14, a receiving slot 27 is arranged at the transparent water supplement container 2. The arrangement of the light source 14 is to produce light and improve the aesthetics.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A water supplement member for atomizers comprising: a vibrator disposed in a seat and producing a mist by vibration, a movable water delivery device corresponding to the vibrator, and a water tank supplying water to the water delivery device;
wherein a slot hole is arranged at the water tank and a conducting pipe on a transparent water supplement container, corresponding to the slot hole, is inserted through the seat to be mounted into the slot hole; a flow deflection hole is arranged around an inner surface of the conducting pipe while an assembly slot hole is disposed on the center of the conducting pipe so as to be assembled with a movable rod with a stopping block on one end thereof and an elastic member is disposed between the stopping block of the movable rod and the assembly slot hole, around the movable rod; a water stop stopper is sleeved on the other end of the movable rod and a projecting block mounted in the slot hole of the water tank is corresponding to the movable rod assembled in the conducting pipe so that the movable rod can extend and retract to make the water stop stopper press against the flow deflection hole for closing the flow deflection hole tightly and release from the flow deflection hole for water supplement.

2. The device as claimed in claim 1, wherein a light source is disposed on the seat and a corresponding receiving slot is arranged at the transparent water supplement container so as to generate light.

3. The device as claimed in claim 1, wherein a water inlet for filling water is disposed on a bottom of the transparent water supplement container and a seal is corresponding to the water inlet for tightly closing of the water inlet.
